(19) United States
(12) Patent Application Publication
(10) Pub. No.: US 2015/0300607 A1
(43) Pub. Date: Oct. 22, 2015

(54) LED LAMP

(71) Applicant: WOOREE LIGHTING CO., LTD., Gyeonggi-do (KR)

(72) Inventors: Yang Hyun CHOI, Gyeonggi-do (KR); Bo Ram KIM, Gyeonggi-do (KR)

(21) Appl. No.: 14/681,296

(22) Filed: Apr. 8, 2015

(30) Foreign Application Priority Data
Apr. 18, 2014 (KR) 10-2014-0046803

(51) Int. Cl. F21V 17/06; F21V 19/00; F21K 99/00

(52) U.S. Cl. CPC F21V 17/06; F21K 9/17; F21K 9/50; F21V 19/003

(57) ABSTRACT

The present disclosure relates to an LED lamp comprising: a light-transmitting tube with an inner surface; a diffusion tube located in tight contact with the inner surface of the light-transmitting tube; and an LED substrate located within the diffusion tube, the substrate having a plurality of LEDs arranged thereon.

### CROSS-REFERENCE TO RELATED PATENT APPLICATION

This application claims priority from Korean Patent Application No. 10-2014-0046803, filed on Apr. 18, 2014 in the Korean Intellectual Property Office, the disclosure of which is incorporated herein by reference in its entirety.

### FIELD

The present disclosure relates generally to an LED lamp, and more particularly to an LED lamp employing a diffusing tube located in tight contact with the inner surface of a light transmitting tube.

### BACKGROUND

This section provides background information related to the present disclosure which is not necessarily prior art.

In general, a lamp converts electrical energy into light energy with power supplied from a power supply, in order to give light to users who may be in a dark place receiving no sunlight or towards dark areas after sunset, serving to create a visual field comparable to one in daylight conditions.

Lamps with these functions are available in various forms. Among others, incandescent lamps that were first developed can be produced at lower costs, but they generate heat more than light, unnecessary wasting a lot of energy and reducing their service life. Because of these, there has been a sharp decline in their use in recent years.

These incandescent lamps were followed by fluorescent lamps which overcame the limitations of the incandescent lamp to a certain extent in terms of the service life and luminous efficiency of a lamp. However, the fluorescent lamp showed high energy consumption at the time of turning on lights, leading to a significant decrease in the service life after the lamp is turned on and off repeatedly, and mercury vapor contained in the lamp are hazardous to human health.

Therefore, there is a continued need for environmentally-friendly and high-efficiency lamps having a long service life. To meet such needs, LED (Light Emitting Diode) lamps are now available in a wide range of forms and structures as a lighting system.

In particular, different technological approaches have been made in order to replace straight tube fluorescent lamps. Examples of relevant prior art documents are Korean Patent Nos. 10-1135533 and 10-1265235 and Korean Patent Application Publication No. 10-2007-0054825.

FIG. 1 shows an example of the straight tube LED lamp disclosed in Korean Paten No. 10-1265235. For the sake of convenient explanation, terms and reference numerals are modified.

A straight tube LED lamp 10 includes end caps 11, a glass tube 12, a fixed tube 13, an LED 14, an LED substrate 15, a diffusion tube 16, and an LED substrate supporting plate 17. Suitable diffusion is required to make use of light emitted from the LED 14 for lighting. This is why the diffusion tube 16 is employed. As an alternative, a diffusing material may be applied on to the inner surface of the glass tube 12. Due to the low light loss, however, the diffusion tube 16 is preferably used.

Nevertheless, with such a diffusion tube this is usually made of plastics and has relatively greater length than width, the tube can be easily bent under heat. This bending behavior of the diffusion tube caused by heat is becoming a bigger issue considering that high-brightness LEDs are now used broadly, and that LEDs having a higher level of brightness tend to generate more heat. As an attempt to prevent the diffusion tube from being bent under heat, according to the related art shown in FIG. 1, a diffusion tube 16 is coupled to the LED substrate supporting plate 17 to encourage the latter to prevent the bending behavior of the diffusion tube. In addition, as the diffusion tube 16 is formed in a semicircular shape, it cannot be perfectly fitted into the glass tube 12 and a marginal space is thus created, causing the bending problem. While a fixed tube 13 was used to resolve the bending problem, it also increased the number of components by adding an LED substrate supporting plate and a fixed tube for example, and further increased the cost of production as well as the number of assembly processes. But above all that, the diffusion tube incapable of being perfectly fitted into the glass tube could not be completely free of getting bent.

### SUMMARY

### Technical Problem

The problems to be solved by the present disclosure will be described in the latter part of the best mode for carrying out the invention.

### Technical Solution

This section provides a general summary of the present disclosure and is not a comprehensive disclosure of its full scope or all of its features.

According to one aspect of the present disclosure, there is provided an LED lamp, comprising a light transmitting tube with an inner surface; a diffusion tube located in tight contact with the inner surface of a light transmitting tube; and an LED substrate having a plurality of LEDs arranged inside thereof.

### Advantageous Effects

The advantageous effects of the present disclosure will be described in the latter part of the best mode for carrying out the invention.

### BRIEF DESCRIPTION OF THE DRAWINGS

FIG. 1 is a view illustrating an example of a straight tube LED lamp disclosed in Korean Patent No. 10-1265235;

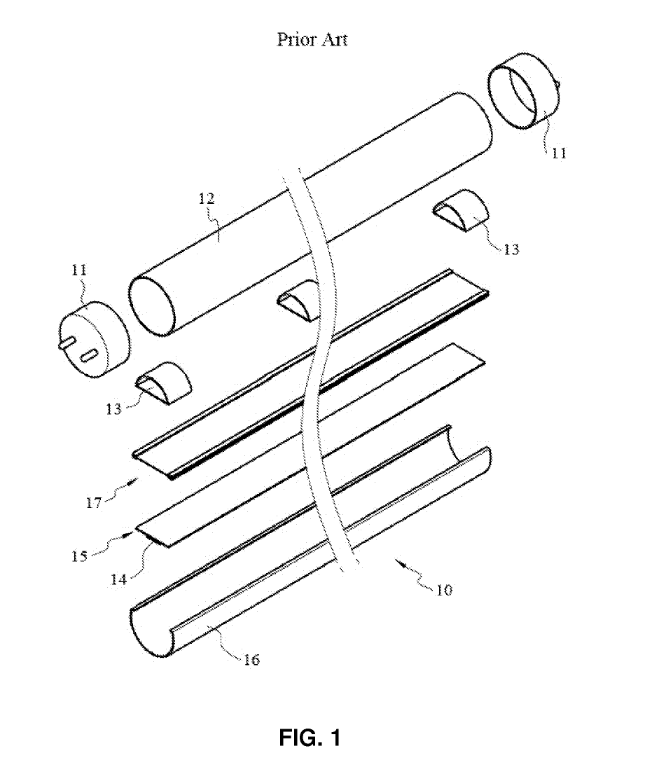

FIG. 2 is an exploded view of an example of an LED lamp according to the present disclosure;

FIG. 3 is a view illustrating an example of the internal structure of a diffusion tube according to the present disclosure;

FIG. 4 is a view illustrating an example of the arrangement of engagement grooves and a support in a diffusion tube according to the present invention;

FIG. 5 is a view illustrating an example of an LED lamp according to the present disclosure; and

FIG. 6 is a view illustrating different ways to make the outer surface of a diffusion tube in tight contact with the inner surface of a transparent tube in an LED according to the present disclosure.

### DETAILED DESCRIPTION

The present disclosure will now be described in detail with reference to the accompanying drawings, without limiting it thereto.

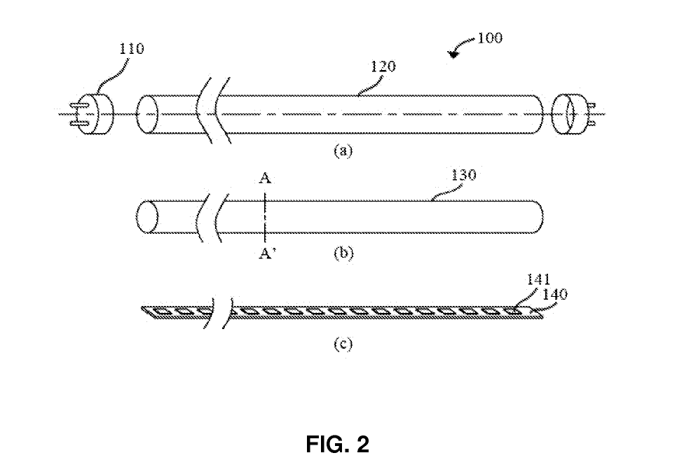

FIG. 2 is an exploded view of an example of an LED lamp according to the present disclosure.

The LED 100 according to the present disclosure includes end caps 110, a light-transmitting tube 120, a diffusion tube 130, and an LED substrate 140 having a plurality of LEDs 141 arranged therein. The light-transmitting tube 120 is preferably made of glass materials so as to allow light to pass therethrough. The diffusion tube 130 is preferably made of PC (polycarbonate) materials so as to diffuse light from the LEDs in a suitable manner. Preferably, the light-transmitting tube 120 and the diffusion tube 130 are identical in shape to each other such that the outer surface of the diffusion tube 130 can be in tight contact with the entire inner surface of the light-transmitting tube 120. The end caps 110 joined to both ends of the light-transmitting tube 120 are preferably made of aluminum or sheet type metallic materials to be able to resist flames and high temperatures. The diffusion tube 130 is placed within the light-transmitting tube 120, and the LED substrate 140 is placed within the diffusion tube 130.

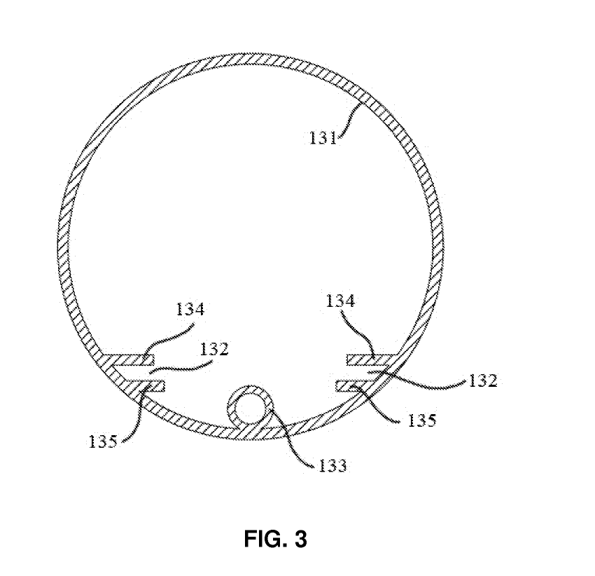

FIG. 3 is a view illustrating an example of the internal structure of a diffusion tube according to the present disclosure.

FIG. 3 shows the cross-sectional view taken along line AA′ of the diffusion tube 130 in FIG. 2. Two engagement grooves 132 are formed on both sides on the inner surface 131 of the diffusion tube 130. These engagement grooves 132 are located, respectively, between two walls 134 and 135 protruded from the inner surface 131. Additionally, there is a support 133 protruded from the inner surface 131 of the diffusion tube 130. The support 133 is located between the engagement grooves 132. The walls 134 and 135 which are protruded from the inner surface of the diffusion tube 130 and create the engagement grooves 132 therebetween, and the support 133 which is also protruded from the inner surface of the diffusion tube 130 are preferably formed into one body with the inner surface of the diffusion tube 130. This diffusion tube 130 having walls 134 and 135 to form engagement grooves 130, and a support 133 can be produced by injection molding.

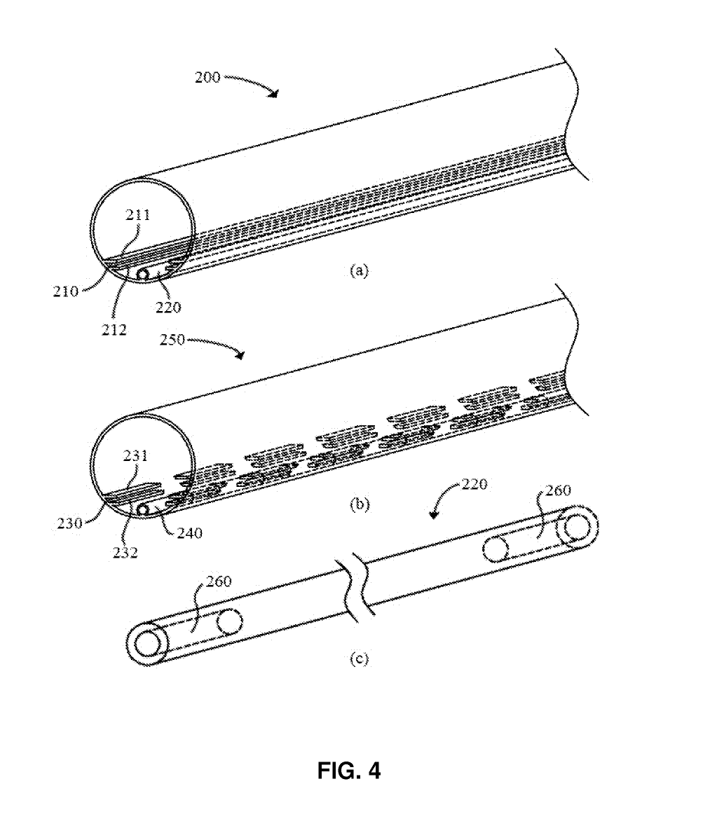

FIG. 4 is a view illustrating an example of a diffusion tube according to the present disclosure, in which engagement grooves and a support are arranged along the longitudinal direction of the diffusion tube.

In FIG. 4(a), the engagement grooves 210 are formed in a continuous manner along the longitudinal direction of the diffusion tube 200. The engagement grooves 210 are formed between two walls 211 and 212 protruded from the inner surface of the diffusion tube. However, it is not absolutely required that the engagement grooves 210 should be formed in a continuous manner along the longitudinal direction of the diffusion tube 200. For instance as shown in FIG. 4(b), the engagement grooves 230 may also be formed in a non-continuous manner along the longitudinal direction of the diffusion tube 250. The engagement grooves 230 are formed between two walls 231 and 232 protruded from the inner surface of the diffusion tube 250.

In FIG. 4(a), the support 220 is formed in a continuous manner along the longitudinal direction of the diffusion tube 200. However, as shown in FIG. 4(b), the support 240 may also be formed in a non-continuous manner along the longitudinal direction of the diffusion tube 250. Both ends of the support 220, 240 have grooves which the end caps are engaged with. FIG. 4(c) shows that the support 220 has a groove 260 on each end.

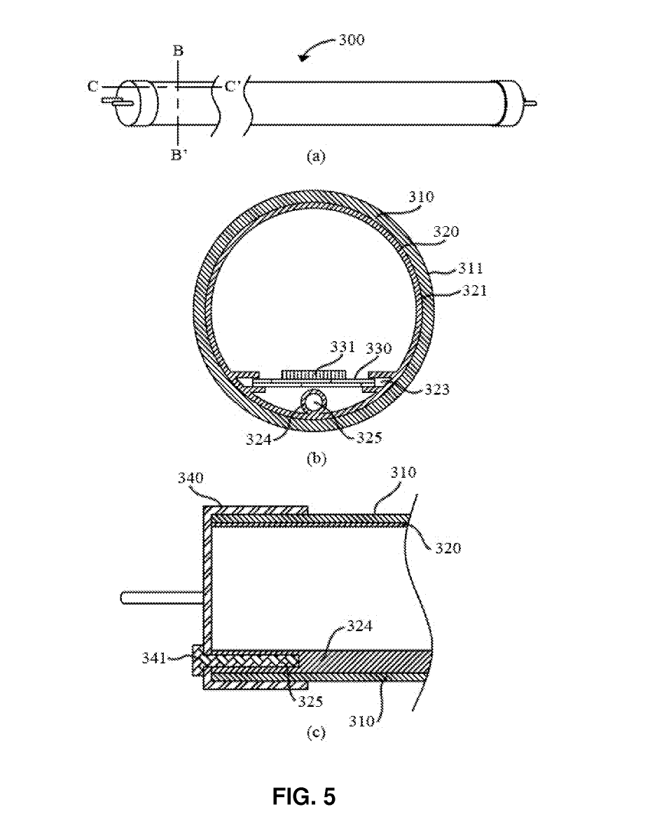

FIG. 5 is a view illustrating an example of an LED lamp according to the present disclosure.

FIG. 5(a) shows the visual appearance of an LED lamp 300 according to the present disclosure, which is not different from that of the related art.

FIG. 5(b) is a cross-sectional view taken along line BB′ of the LED lamp 300. There are shown in this cross-sectional view a light-transmitting tube 310, a diffusion tube 320, engagement grooves 323, an LED substrate 330 having an LED 331 arranged thereon, and a support 324 having a groove 325 therein. While the LED 331, the engagement grooves 323 and the support 324 are all shown for the sake of convenient explanation, the LED 331 which is arranged in a non-continuous manner on the LED substrate 330 may not be visible on the cross-sectional view, depending on a cutaway position. Also, the engagement grooves 323, if being formed in a non-continuous manner along the longitudinal direction of the diffusion tube 320, may not be visible on the cross-sectional view, depending on a cutaway position. Likewise, the support 324, if being formed in a non-continuous manner along the longitudinal direction of the diffusion tube 320, may not be visible on the cross-sectional view, depending on a cutaway position. In addition, even those grooves formed on both ends of the support 324 may not be visible on the cross-sectional view, depending on a cutaway position. Unlike known related art, the outer surface 321 of the diffusion tube 320 is in tight contact with the entire inner surface 311 of the light-transmitting tube 310 so as to prevent the diffusion tube 320 from being bent under heat. In order to prevent this bending behavior of the diffusion tube 320 caused by heat, the light-transmitting tube 310 is preferably made of a material having a lower thermal expansion coefficient than that of a material of the diffusion tube 320. Moreover, compared with the LED substrate 330 having engagement grooves 323 supporting only the both ends of the LED substrate 330, the LED substrate 330 being supported by the support 324 is no more vulnerable to vibrations caused by external shock.

FIG. 5(c) shows that an end cap 340 is fixed into a groove 325 of the support 324 by means of a screw 341. FIG. 5(c) is a cross-sectional view taken along line CC′. While this example illustrated the use of a screw 341 for engaging the end cap 340 with the groove 325, other joining technique employing the groove 325 may also be applied.

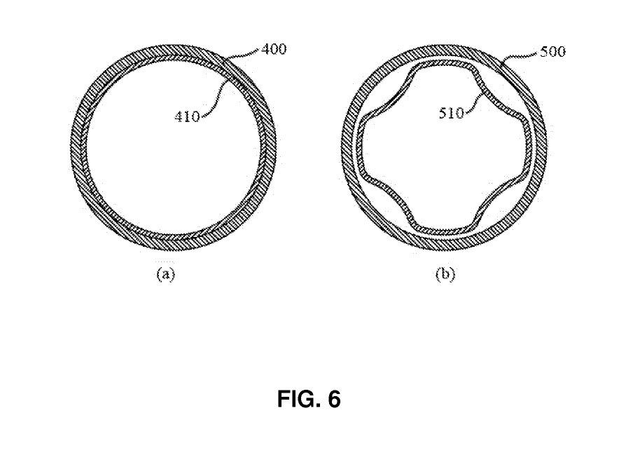

FIG. 6 is a view illustrating different ways to make the outer surface of a diffusion tube in tight contact with the inner surface of a transparent tube in an LED according to the present disclosure.

FIG. 6(a) illustrates a case where the diffusion tube 400 has a shape identical with that of the transparent tube 410.

FIG. 6(b) illustrates a case where the diffusion tube 500 has a shape different from that of the transparent tube 410. In this case, part of the outer surface of the diffusion tube 510 is in tight contact with the inner surface of the transparent tube in such a way that no space is created to allow the bending behavior of the diffusion tube 510.

While FIG. 6 illustrates the diffusion tube and the transparent tube of an elongated shape in the longitudinal direction, having a circular cross section, these tubes can have different cross section shapes from the circular one, such as, polygonal shapes including square and triangle, or oval shapes.

The following will now describe various exemplary embodiments of the present disclosure.
(1) An LED lamp, characterized by comprising: a light-transmitting tube with an inner surface; a diffusion tube located in tight contact with the inner surface of the light-transmitting tube; and an LED substrate located within the diffusion tube, the substrate having a plurality of LEDs arranged thereon.
(2) The LED lamp, wherein the diffusion tube has engagement grooves formed on both sides of the inner surface of the diffusion tube, along the longitudinal direction thereof.
(3) The LED lamp, wherein the LED substrate engages in the engagement grooves.
(4) The LED lamp, wherein the diffusion tube has a support formed on the inner surface of the tube, along the longitudinal direction thereof.
(5) The LED, wherein the support has grooves on both ends.
(6) The LED, wherein the support is located under the LED substrate.
(7) The LED lamp, wherein the diffusion tube is made of a polycarbonate material.
(8) The LED lamp, wherein the light-transmitting tube is made of a glass material.
(9) The LED lamp, wherein the material of the light-transmitting tube has a thermal expansion coefficient lower than that of the material of the diffusion tube.
10) The LED lamp, wherein the light transmitting tube and the diffusion tube are identical in shape to each other.

With the LED lamp according to the present disclosure, it is possible to prevent the diffusion tube from bending due to heat generated from the LEDs.

In the LED lamp according to the present disclosure, the engagement grooves and the support can be formed into one body with the diffusion tube, which consequently reduces the number of parts and further, the number of assembly processes.

What is claimed:

1. An LED lamp comprising:
a light-transmitting tube with an inner surface;
a diffusion tube located in tight contact with the inner surface of the light-transmitting tube; and
an LED substrate located within the diffusion tube, the substrate having a plurality of LEDs arranged thereon.

2. The LED lamp according to claim 1, wherein the diffusion tube has engagement grooves formed on both sides of the inner surface of the diffusion tube, along the longitudinal direction thereof.

3. The LED lamp according to claim 2, wherein the LED substrate engages in the engagement grooves.

4. The LED lamp according to claim 1, wherein the diffusion tube has a support formed on the inner surface of the tube, along the longitudinal direction thereof.

5. The LED lamp according to claim 4, wherein the support has grooves on both ends.

6. The LED lamp according to claim 4, wherein the support is located under the LED substrate.

7. The LED lamp according to claim 1, wherein the diffusion tube is made of a polycarbonate material.

8. The LED lamp according to claim 1, wherein the light-transmitting tube is made of a glass material.

9. The LED lamp according to claim 1, wherein the material of the light-transmitting tube has a thermal expansion coefficient lower than that of the material of the diffusion tube.

10. The LED lamp according to claim 1, wherein the light transmitting tube and the diffusion tube are identical in shape to each other.

11. The LED lamp according to claim 10, wherein the diffusion tube has engagement grooves formed on both sides of the inner surface of the diffusion tube, along the longitudinal direction thereof.

12. The LED lamp according to claim 11, wherein the diffusion tube has a support formed on the inner surface of the tube, along the longitudinal direction thereof.

13. The LED lamp according to claim 12, wherein the support is located under the LED substrate.
